(19) United States
(12) Patent Application Publication
(10) Pub. No.: US 2006/0288829 A1
(43) Pub. Date: Dec. 28, 2006

(54) Hardened Utility Knife, With Optional Nail Set and Pry Bar

(76) Inventor: Robert Sipperly, Greenwich, NY (US)

Correspondence Address: LAW OFFICE OF JAY R. YABLON, 910 NORTHUMBERLAND DRIVE, SCHENECTADY, NY, 12309-2814, US

(21) Appl. No.: 11/532,941

(22) Filed: Sep. 19, 2006

(51) Int. Cl. B26D 1/00; F41B 13/02

(52) U.S. Cl. 83/13; 30/162; 30/125; 30/336

(57) ABSTRACT

A utility knife body apparatus and related method of use, comprising: a blade slot for containing part of a utility knife blade interior to the utility knife body while a remaining part of the utility knife blade protrudes exterior to the utility knife body; a material comprising a shattering impact resistance greater than or equal to the shattering impact resistance of steel; a one-piece fabrication omitting a separation juncture for separating the knife body into two halves; and a blade position securing apparatus for securing the utility knife blade firmly in position relative to the utility knife body, substantially without relative movement between the utility knife blade and the utility knife body during hammering of the utility knife body.

### FIELD OF THE INVENTION

This invention relates to the field of carpentry tools, and particularly to a utility knife which is hardened so as to permit the knife to be hammered as needed for “in-place” cutting, i.e., cutting without removal-from-site of the material being cut, in combination with an optional nail set and pry bar.

### BACKGROUND OF THE INVENTION

Utility knifes are a central part of any carpenter's toolkit. A conventional utility knife 1 comprises a utility knife blade 11 (hereafter, simply blade 11) connected to a knife body 12 typically fabricated of a molded plastic or cast aluminum. Typically, blade 11 retracts into knife body 12 via a retraction slide 13, in a manner that is well-known and widely practiced in the art. Also, knife body 12 often comprises a hollow interior storage region 14 for storing spare blades. To access the spare blades, and indeed, to seat a new blade 11 into position for use, knife body 12 is typically fabricated in two halves sandwiched together at a separation juncture 16 running about the perimeter of knife body 12. The two halves are held together by a centrally-located connector screw 17 or similar connecting device. To change a blade (even for a knife without hollow interior storage region 14), it is necessary to remove connector screw 17, separate the two halves along separation juncture 16, seat the new blade 11 into position (engaged with retraction slide 13 if one is present), and then reconnect the two halves with connector screw 17. All of the foregoing is well-known and widely-practiced in the art.

While retractability and spare blade storage internally to knife body 12 are desirable features, and plastic and aluminum are relatively inexpensive materials from which to fabricate knife body 12, these features nevertheless have some drawbacks.

In particular, there are many circumstances where it is desirable to hammer knife body 12 above the blade proximate its top front end 18 and/or proximate its rear end 15 in order to apply an impulse to the blade 11, particularly for “in-place” cutting wherein the material being cut does not need to be removed from site. A rear strike at 15 effectively uses the blade as a pointed chisel, while top strike at 18 effectively uses the blade as a wide-blade chisel. The circumstances where such hammering is desirable include but are not limited to mortising, and cutting various material (sheet metal, wire, wood, etc.) in place, without removal-from-site, often in very limited space. However, this hammering can cause the blade to retract inadvertently, or to become jostled and improperly seated. Further, because of the plastic or aluminum materials typically used to fabricate knife body 12, and because of the two-half body design, this knife body 12 will shatter after repeated strikes.

Additionally, there are other carpentry tools which it is desirable to have readily available to the carpenter. Among these are a nail set and a pry bar. Often, these are separate tools, but it would be desirable to combine such tools into the utility knife and also to do in a way that synergistically enhances the ability of the user to repeatedly strike rear end 15 in an effective way, without deleterious effect on the knife body 12 itself.

U.S. Pat. No. 6,532,614 combines a paint scraper and a nail set into one tool. However, the paint scraper cannot be employed as a utility knife, either in the conventional manner, or by hammering. Additionally, this patent lacks any sort of pry bar mechanism.

U.S. Pat. No. 4,028,758 discloses a combination utility knife and staple remover. However, the staple remover is not configured in such a way as to enable hammering of the utility knife, nor is the utility knife sufficiently hardened to permit the same.

U.S. Pat. No. 5,911,761 is of background interest as an example of a utility knife combined with a second tool, in this case, a stapler. U.S. Pat. No. 4,635,309 is of similar background interest because it contains a second tool which is a marker. This marker is stored in a storage compartment, however, not integral to the tool. U.S. Pat. No. 6,874,188 is of interest because it is also a multi-tasking utility tool.

U.S. Pat. No. 4,068,375 is of interest because it is referred to as a “heavy duty” utility knife. Whatever it is that ostensibly makes this knife “heavy duty,” this knife is clearly not configured in such a way as to be readily hammered, and it lacks other tools.

U.S. Pat. No. 4,080,734 is of interest because it contains a blade portion and is configured so that it can be hammered, but it is not a utility knife and cannot in any way be used for the types of applications to which utility knifes are commonly applied. It also lacks any other tools.

U.S. Pat. No. 5,979,913 is of interest because it is used to set, but also used to cut. The cutting tool, however, is a drill bit, which is very unlike a utility knife in structure or function.

Finally, U.S. Pat. No. 7,003,833 is of interest because it does combine a knife with a punch (as well as other tools). But, the underlying tool is a multi-function pocket knife, not a utility knife.

It would be desirable to have available a hardened utility knife which by virtue of being hardened can be easily hammered without breakage.

It would further be desirable to have available a utility knife which also comprises a set tool (e.g., a nail set) and/or a pry bar, and for which the set tool and the pry bar are configured in relation to the utility knife so as to provide an enhanced surface for striking the tool with a hammer to impart impulse to the utility knife blade.

It is especially desirable to have such a hardened utility knife which can be hammered for cutting of objects in place, i.e., without removal of said objects from site.

### SUMMARY OF THE INVENTION

Disclosed herein is a utility knife body apparatus and related method of use, comprising: a blade slot for containing part of a utility knife blade interior to the utility knife body while a remaining part of the utility knife blade protrudes exterior to the utility knife body; a material comprising a shattering impact resistance greater than or equal to the shattering impact resistance of steel; a one-piece fabrication omitting a separation juncture for separating the knife body into two halves; and a blade position securing apparatus for securing the utility knife blade firmly in position relative to the utility knife body, substantially without relative movement between the utility knife blade and the utility knife body during hammering of the utility knife body.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 is a side plan view of a retractable-blade utility knife typical of the prior art.

FIG. 2 is a side plan view of a hardened utility knife in a preferred embodiment of the invention.

FIG. 3 is a bottom plan view of the utility knife of FIG. 2, as viewed from the direction along the line 3-3 in FIG. 2.

FIG. 4 is a rear plan view of the utility knife of FIG. 2, as viewed from the direction along the line 4-4 in FIG. 2.

### DETAILED DESCRIPTION

FIG. 2 illustrates a hardened utility knife 2 in a preferred embodiment of the invention, from a side plan view. Blade 11 is a standard utility knife blade, but hardened knife body 22 is different from the customary knife body 12 in a number of salient ways:

First, hardened knife body 22 is fabricated from hard, durable, shatterproof steel rather than the plastic, aluminum, or similar materials from which conventional utility knifes 1 are fabricated. More generally, the material employed comprises a shattering impact resistance greater than or equal to the shattering impact resistance of steel.

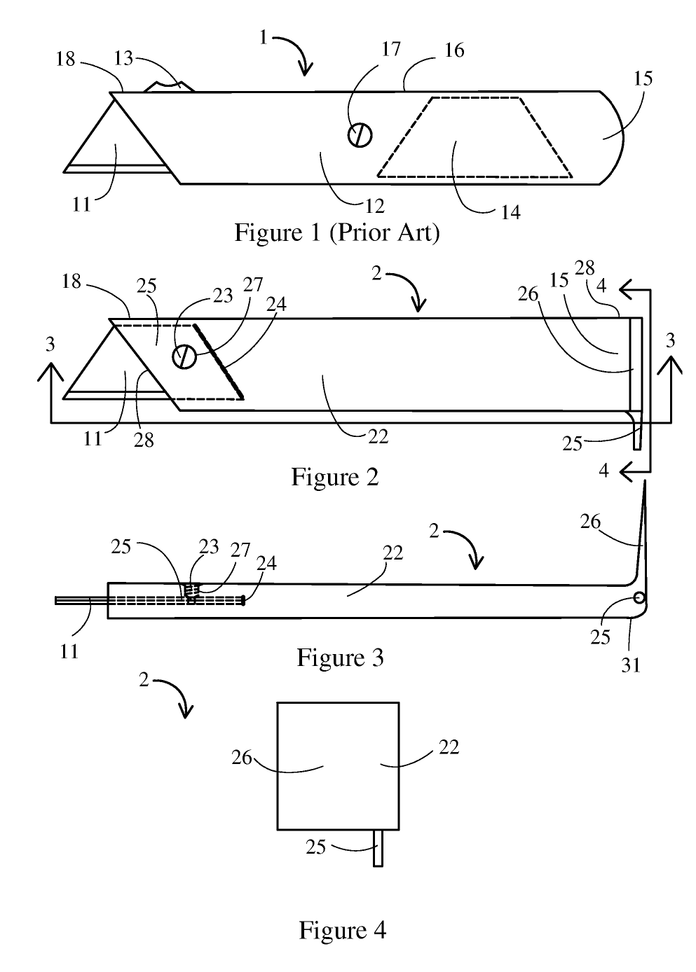

Second, hardened knife body 22 including blade slot 25 is fabricated in a one piece. This is in contrast to being fabricated in two halves as is customary in the art and as is illustrated by the separation juncture at 16 and connector screw 17 of the prior art knife body 12 in FIG. 1. This one-piece unibody fabrication is important to enhance the durability and shatter-resistance of hardened knife body 22.

Third, given this unibody fabrication, when it comes time for changing blade 11, there are no “two halves” to disassemble and reassemble. Rather, a set screw 23 disposed through a set screw aperture 27 of hardened knife body 22 is loosened, the old blade 11 is removed from blade slot 25 through the front end 28 of hardened knife body 22 (not by disassembly of the body into two halves), a new blade 11 is inserted into blade slot 25 through the front end 28 of hardened knife body 22 (not by reassembly of two body halves), and set screw 23 is tightened to tightly secure new blade 11 into a cutting position. The cutting configuration resulting from this method of blade insertion will be referred to here as a “front-inserted position.”

Fourth, also due to this unibody fabrication, hardened knife body 22 omits the hollow interior storage region 14 used in most prior art utility knifes 1 for storing spare blades, in favor of this one-piece, unibody fabrication for added durability.

Fifth, blade 11 is not retractable, or, more to the point, hardened knife body 22 omits the usual retraction means (e.g., retraction slide 13) for enabling blade 11 to be retracted into hardened knife body 22 when not in use. Rather, blade 11 is fixed in position using a blade position securing apparatus comprising, for example, not limitation, the set screw 23 as illustrated. The function of blade position securing apparatus is for securing blade 11 firmly in position, substantially without movement or jostling relative to hardened utility knife body 22, while utility knife body 22 is hammered either proximate top front end 18 or proximate rear end 15. It should be apparent that the customary retractability would compromise the secure positioning of blade 11 when knife body 22 is hammered.

Sixth, optionally, though preferably, the blade position securing apparatus of hardened knife body 22 further comprises a blade retention barrier 24 proximate the rear of blade slot 25, which makes contact with the rear end of blade 11 and, in combination with set screw 23, further prevents blade 11 from being impacted or jostled when hardened knife body 22 is hammered.

Finally, hardened knife body 22 preferably comprises at least one additional tool proximate the rear end 15 of hardened utility knife body 22, disposed substantially perpendicularly to the length of hardened utility knife body 22. In this case, two additional tools are illustrated, namely, a set tool 25 and a pry bar 26, and these two additional tools are also disposed perpendicularly to one another. That is, knife body 22, set tool 25, and pry bar 26 are mutually-perpendicularly disposed relative to one another. These additional tools, and their perpendicular orientation relative to hardened knife body 22 and to one another, simultaneously achieve three objectives:

First, as is made clear from the rear plan view of FIG. 4, the perpendicular orientation of these two tools presents a widened target region for striking the rear end 15 of hardened knife body 22 with a hammer. Thus, set tool 25, and pry bar 26 double as an enhanced hammering target for hammering the rear of knife body 22.

Second, the perpendicular orientation of these two tools facilitates driving these two tools by hammering hardened knife body 22 from the rear-top 28 when set tool 25 is being employed, and from the rear-side 31 when pry bar 26 is being employed. It is understood that the positions of these additional tools can be interchanged or otherwise varied within the scope of this disclosure and its associated claims.

Third, the additional tools in their own right are available for use in a single apparatus which includes utility knife 2. Because hardened knife body 22 is fabricated from a hardened material in one piece, it becomes possible without damage to hardened knife body 22 to hammer the rear end 15 of hardened knife body 22 from above proximate 28 in order to drive set tool 25 for setting, e.g., a nail. And, also because hardened knife body 22 is fabricated from a hardened material in one piece, it becomes possible without damage to hammer the rear end 15 of hardened knife body 22 from the side proximate 31, in order to drive pry bar between whatever two workpiece members need to be pried apart. Additionally, because of the hardening, any torques applied in prying will not cause damage to knife body 22.

Additionally, it is preferable for the “at least one additional tool” to be molded in one piece with knife body 22, further extending the unibody fabrication, as this ensures maximal structural integrity under repeated hammering and use of these additional tools.

It should be apparent to someone of ordinary skill looking at FIGS. 2 through 4 and especially FIG. 4, although the “at least one additional tool disposed substantially perpendicularly to the length of hardened knife body 22″ proximate the rear end of knife body 22 comprises, in these illustrations, set tool 25 and pry bar 26, that other tools which are suitable for hammering may also be substituted in place of one or both of the illustrated set tool 25 and pry bar 26. For example, not limitation, the at least one additional tool suitable for hammering may comprise an awl for punching a hole into a surface, or the bladed end of an ordinary (truncated) chisel for a degree of strength not possible from a customary utility knife blade 11, or a so-called “cat's paw” for getting under the head of and aiding in the removal of nails which are already set. The appending of other hammerable tools not specifically mentioned here, but of suitable dimension to be appended to the rear end 15 of a hardened utility knife body 22, are also considered to be within the scope of this disclosure and its associated claims.

While only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. A utility knife body apparatus, comprising:
a blade slot for containing part of a utility knife blade interior to said utility knife body while a remaining part of said utility knife blade protrudes exterior to said utility knife body;
a material comprising a shattering impact resistance greater than or equal to the shattering impact resistance of steel;
a one-piece fabrication omitting a separation juncture for separating said knife body into two halves; and
a blade position securing apparatus for securing said utility knife blade firmly in position relative to said utility knife body, substantially without relative movement between said utility knife blade and said utility knife body during hammering of said utility knife body.

2. The apparatus of claim 1, further comprising said utility knife blade.

3. The apparatus of claim 1, further comprising:
a set screw aperture; and
said blade position securing apparatus comprising a set screw disposed through said set screw aperture and tightly contacting said blade.

4. The apparatus of claim 1, said blade position securing apparatus comprising a blade retention barrier proximate a rear of said blade slot, for contacting a rear of said blade.

5. The apparatus of claim 1, wherein:
the utility knife blade seats in said utility knife body by being in a front-inserted position through said blade slot; and
the utility knife blade is secured into a cutting position by a set screw being in a tightened state against said blade.

6. The apparatus of claim 1, omitting retraction means for retracting said remaining part of said utility knife blade into said utility knife body.

7. The apparatus of claim 1, omitting an interior storage region for storing spare blades.

8. The apparatus of claim 1, further comprising:
at least one additional tool proximate said rear end of said utility knife body, disposed substantially perpendicularly to a length of said utility knife body.

9. The apparatus of claim 8, said at least one additional tool comprising a nail set.

10. The apparatus of claim 8, said at least one additional tool comprising a pry bar.

11. The apparatus of claim 8, said at least one additional tool comprising additional tools selected from the additional tool group consisting of: a nail set, a pry bar, an awl, a chisel, and a cat's paw.

12. The apparatus of claim 1, further comprising:
at least two additional tools proximate said rear end of said utility knife body, disposed substantially perpendicularly to a length of said utility knife body, and further disposed substantially perpendicularly relative to one another.

13. The apparatus of claim 12, said at least two additional tools comprising a nail set and a pry bar.

14. The apparatus of claim 12, said at least two additional tools comprising a comprising additional tools selected from the additional tool group consisting of: a nail set, a pry bar, an awl, a chisel, and a cat's paw.

15. A method of using a utility knife, comprising:
providing a utility knife body fabricated in one piece omitting a separation juncture for separating said knife body into two halves;
providing said utility knife body comprising a shattering impact resistance greater than or equal to the shattering impact resistance of steel;
hammering said one-piece utility knife body; and
securing a utility knife blade firmly in position relative to said utility knife body through a blade slot of said utility knife body, substantially without relative movement between said utility knife blade and said utility knife body during said hammering, with part of said utility knife blade interior to said utility knife body and a remaining part of said utility knife blade protruding exterior to said utility knife body, using a blade position securing apparatus.

16. The method of claim 15, further comprising:
disposing said blade position securing apparatus comprising a set screw into tight contact with said blade, through a set screw aperture of said utility knife body.

17. The method of claim 15, said blade position securing apparatus comprising a blade retention barrier proximate a rear of said blade slot; further comprising:
disposing a rear of said blade into contact with said blade retention barrier.

18. The method of claim 15, further comprising changing said utility knife blade by:
loosening a set screw tightened against said blade;
removing said blade through a front end of said blade slot;
inserting a new blade through said front end of said blade slot; and
tightening said set screw against said new blade thereby securing said new blade into a cutting position.

19. The method of claim 15, further comprising providing said utility knife body omitting retraction means for retracting said remaining part of said utility knife blade into said utility knife body.

20. The method of claim 15, further comprising providing said utility knife body omitting an interior storage region for storing spare blades.

21. The method of claim 15, further comprising:
providing at least one additional tool proximate said rear end of said utility knife body, disposed substantially perpendicularly to a length of said utility knife body; and
hammering said utility knife body to drive said at least one additional tool.

22. The method of claim 21, said at least one additional tool comprising a nail set.

23. The method of claim 21, said at least one additional tool comprising a pry bar.

24. The method of claim 21, said at least one additional tool comprising additional tools selected from the additional tool group consisting of: a nail set, a pry bar, an awl, a chisel, and a cat's paw.

25. The method of claim 15, further comprising:
providing at least two additional tools proximate said rear end of said utility knife body, disposed substantially perpendicularly to a length of said utility knife body, and substantially perpendicularly relative to one another; and
hammering said utility knife body to drive one of said at least two additional tools.

26. The method of claim 25, said at least two additional tools comprising a nail set and a pry bar.

27. The method of claim 25, said at least two additional tools comprising a comprising additional tools selected from the additional tool group consisting of: a nail set, a pry bar, an awl, a chisel, and a cat's paw.
